(19) United States
(12) Patent Application Publication
(10) Pub. No.: US 2013/0214196 A1
(43) Pub. Date: Aug. 22, 2013

(54) ELECTROLYTE FORMULATION FOR USE IN PHOTOELECTROCHEMICAL DEVICES

(71) Applicants: Damion Milliken, Queanbeyan (AU); Syed Zaka Ahmed, Queanbeyan (AU); Nancy Jiang, Queanbeyan (AU)

(72) Inventors: Damion Milliken, Queanbeyan (AU); Syed Zaka Ahmed, Queanbeyan (AU); Nancy Jiang, Queanbeyan (AU)

(73) Assignee: DYESOL INDUSTRIES PTY LTD, Queanbeyan, NSW (AU)

(21) Appl. No.: 13/881,764

(22) PCT Filed: Oct. 25, 2011
(86) PCT No.: PCT/AU2011/001356

§ 371 Date: May 2, 2013

(30) Foreign Application Priority Data
Oct. 26, 2010 (AU) 2010904758
Nov. 19, 2010 (AU) 2010905131

(51) Int. Cl. H01G 9/20

(52) U.S. Cl. CPC H01G 9/2009
USPC 252/62.2

(57) ABSTRACT

An electrolyte formulation for use in photoelectrochemical devices is disclosed comprising a thickening agent, wherein the thickening agent is dissolved in the electrolyte. The thickening agent may be polymeric.

This application is a National Stage completion of PCT/AU2011/001356 filed Oct. 25, 2011, which claims priority from Australian patent application serial no. 2010905131 filed Nov. 19, 2010 and Australian patent application serial no. 2010904758 filed Oct. 26, 2010.

### TECHNICAL FIELD

The present invention relates to electrolyte formulations for use in photoelectrochemical devices and particularly relates to their use in dye-sensitized solar cells.

### BACKGROUND TO THE INVENTION

Photoelectrochemical devices in the form of dye-sensitized solar cells (DSC) typically include an arrangement of a dye-sensitized working electrode mounted on a first substrate, a counter electrode mounted on a second substrate, and an electrolyte which is sealed between the substrates. The electrolyte completes a photoelectrochemical circuit between the electrodes.

In order to construct DSC cells it is necessary to introduce the electrolyte between the electrodes. To date, one of the most common techniques used has been vacuum back-filling with liquid electrolyte. In this technique, the cell is constructed without electrolyte. Air is then evacuated from the void between the electrodes using a vacuum source, typically by way of a small fill-hole or the like provided in one of the substrates of the cell or at a region of the seal between the two substrates. A source of liquid electrolyte is then put into fluid communication with the fill-hole by way of a valve arrangement. The electrolyte is drawn into the cell because of the lower than ambient air pressure inside the cell and the fill hole is then sealed. Variations on this approach eliminating the need for vacuum utilize two holes, one through which pressurized electrolyte fluid enters and the other via which the gas contained between the substrates leaves.

Another technique is to build the device up in layers by preparing two substrates with electrodes, applying electrolyte to one of the electrodes and then bringing both substrates together. However, the liquid electrolytes used to date suffer from problems of splashing during deposition and containment during the processes of laminating the two substrates. To address this, the electrolyte may be provided in the form of a rheologically modified electrolyte, for instance thickened to a higher viscosity or gelled. The increased viscosity of a gel electrolyte assists in retaining the electrolyte in position during cell assembly.

To date, gelled electrolytes have been provided in two-phase formulations being a liquid electrolyte, with an added inorganic or polymeric thickening agent such as nano-particulate silica or polyvinylidene fluoride. The thickening agent is dispersed as fine particles in the liquid electrolyte. Gelled electrolytes have been found to be problematic in that they can block dispensing system nozzles and are also prone to separation over time due to their multi-phase nature.

There remains a need for improved electrolyte formulations which are both stable over the long-term as well as suitable for a variety of manufacturing methodologies employing different deposition technologies.

### SUMMARY OF THE INVENTION

In a first aspect the present invention provides an electrolyte formulation for use in photoelectrochemical devices including: a thickening agent; wherein the thickening agent is dissolved in the electrolyte.

The thickening agent may be polymeric.

The thickening agent may include a polyvinyl alkyl aldehyde resin such as polyvinyl butyral.

The thickening agent may include poly-ethylene glycol.

The thickening agent may include an alkyl cellulose such as ethyl cellulose.

The thickening agent may include a poly-alkylene oxide such as poly-ethylene oxide.

The thickening agent may include, a hydroxyl alkyl cellulose such as hydroxy propyl cellulose.

The thickening agent may include any of polyacrylonitrile, poly-vinyl acetate, poly(alkylene carbonate) copolymers, or a poly vinyl alkyl ether such as poly vinyl (m)ethyl ether.

The thickening agent may be present in an amount between 0.1 wt % to 20 wt %.

The thickening agent may be present in an amount between 2 wt % to 9 wt %.

The thickening agent may be present in an amount of about 6 wt %.

The formulation may further include a normally nanoparticulate metallic ion based compound.

In a second aspect the present invention provides a photoelectrochemical device including an electrolyte formulation according to the first aspect of the invention.

The photoelectrochemical device may be a dye-sensitized solar cell.

### BRIEF DESCRIPTION OF THE DRAWINGS

An embodiment of the present invention will now be described, by way of example only, with reference to the accompanying drawings, in which:

FIG. 1 is a graph illustrating experimental results of measurements of electrolyte rheology of electrolyte samples;

FIG. 2 is a graph illustrating experimental results of ionic conductivity of some of the electrolyte samples of FIG. 1; and

FIG. 3 is a graph illustrating experimental results of long-term stability of dye-sensitized solar cells fabricated using some of the electrolyte formulations of FIG. 1.

### DETAILED DESCRIPTION OF THE PREFERRED EMBODIMENT

An electrolyte formulation according to an embodiment of the invention is prepared in the following manner:

a) Prepare the electrolyte (redox couple based electrolyte in nitrile based solvent). Such electrolytes are known in the art and so no detailed explanation is provided here.

b) Filter electrolyte to remove any residual solid particles.

c) Add polymeric thickening agent, e.g., B-79 polyvinyl butyral, in an amount of around 6 wt %; optionally add metal ion based modifier if required.

d) Homogenize by mixing (e.g., shake or stir using appropriate apparatus).

e) Optionally heat, e.g., in oven overnight or within suitable heating jackets, mantles or similar equipment, optionally this heating can be combined with agitation such as used in (d).

f) Repeat/continue d) and e) until thickening agent is fully dissolved, and if used, the metal ion based additive is homogeneously dispersed.

g) Filter electrolyte formulation to remove any residual solid particles above a desired threshold size.

The electrolyte formulation produced is now ready for use in fabricating dye solar cells in either a known manner, such as vacuum backfilling, or a novel manner such as described below.

The addition of the polymeric thickening agent initially engenders a Newtonian increase in viscosity; and at higher loadings a pseudoplastic (shear thinning) behavior. Control of the rheological behavior of the electrolyte facilitates a wider and more convenient deposition process window and allows use of non-traditional electrolyte filling technologies. Further, the effects of the polymeric thickening agent in altering surface tension and altering other fluid characteristics of the electrolyte are also helpful for facilitating greater control of the flow behavior of the electrolyte once deposited onto a substrate. In addition, increasing the viscosity of the electrolyte and increasing the surface tension are believed to have beneficial effects on longer-term stability of cells produced with this electrolyte due to diminished capability of the electrolyte to escape from cells.

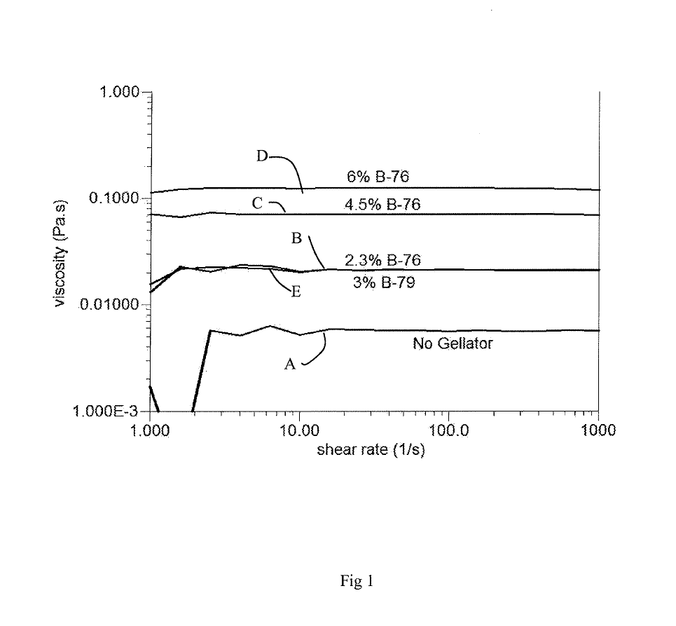

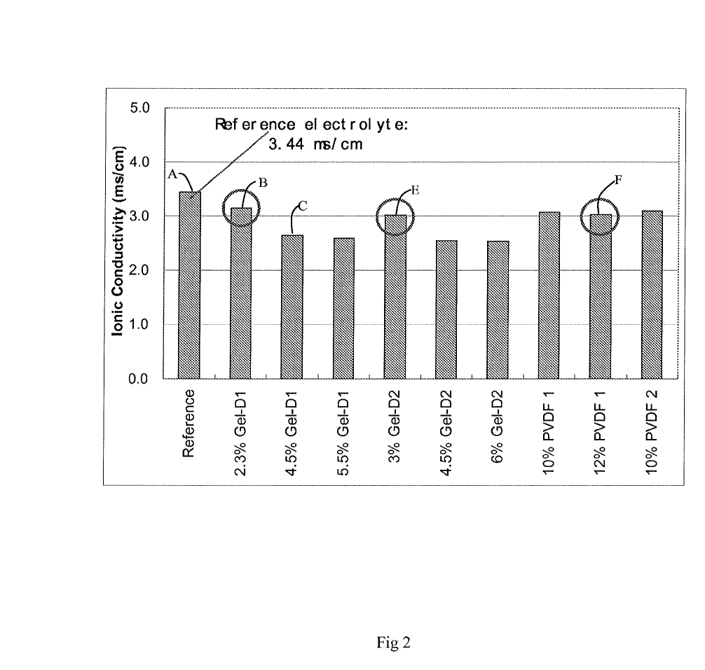

Referring to FIGS. 1, 2 & 3, experimental results are shown in the form of graphs for a number of thickened electrolyte formulations. Formulation A is an unthickened reference sample. Formulations B, C and D are based on formulation A, with B-76 molecular weight polyvinyl butyral added in concentrations of 2.3%, 4.5% and 6% respectively. Formulation E is based on formulation A, with B-79 molecular weight polyvinyl butyral added at a concentration of 3%.

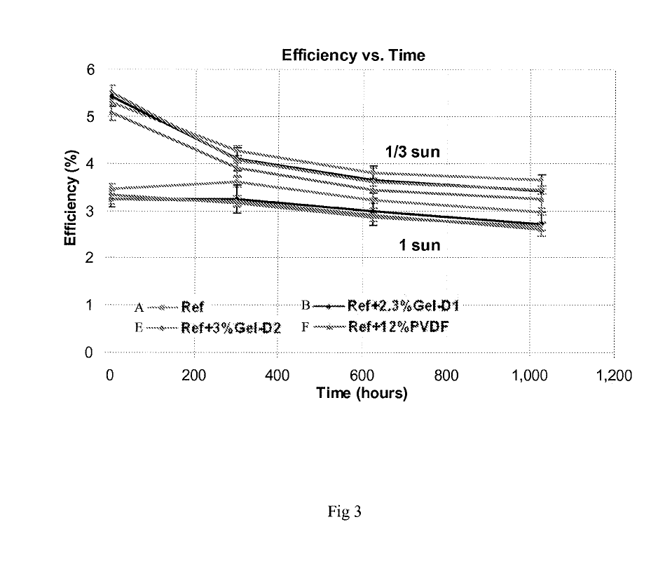

Referring to FIG. 1, the rheology of each sample is represented as viscosity against shear rate. FIG. 2 represents ionic conductivity, and FIG. 3 represents long term stability as efficiency against time. The results demonstrate that formulations B, C, D & E have acceptable conductivity and long term stability and confirm their suitability for use in viable dye sensitized solar cells.

In the embodiment described above, a thickening agent being a polyvinyl alkyl aldehyde resin in the form of polyvinyl butyral was used. Testing has shown that other thickening agents can be used to similar effect such as poly-ethylene glycol, alkyl celluloses such as ethyl cellulose, poly-alkylene oxides such as poly-ethylene oxide; hydroxyl alkyl celluloses such as hydroxy propyl cellulose; polyacrylonitriles; poly-vinyl acetates, poly(alkylene carbonate) copolymers, or poly vinyl alkyl ethers such as poly vinyl (m)ethyl ether.

Furthermore, testing has shown that these thickening agents may optionally also be used in conjunction with more traditional electrolyte gelling agents, for instance metal ion based compounds such as silica, alumina, clays, talc, titania, etc., or polyvinylidene fluoride or copolymer variants thereof.

It can be seen that embodiments of the invention give at least one of the following advantages:
Use of dissolved thickening agent addresses problem of blocked dispensing systems
Viscosity of electrolyte can be controlled to optimize a variety of deposition techniques
Surface tension of electrolyte is increased and controlled to improve flow of electrolyte during application stage
Cell performance is not significantly affected

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1-14. (canceled)

15. An electrolyte formulation for use in photoelectrochemical devices including:
a thickening agent;
wherein the thickening agent is dissolved in the electrolyte; and
the thickening agent is polymeric.

16. The electrolyte formulation according to claim 15, wherein the thickening agent includes a polyvinyl alkyl aldehyde resin.

17. The electrolyte formulation according to claim 16, wherein the polyvinyl alkyl aldehyde resin is as polyvinyl butyral.

18. The electrolyte formulation according to claim 15, wherein the thickening agent includes poly-ethylene glycol.

19. The electrolyte formulation according to claim 15, wherein the thickening agent includes an alkyl cellulose.

20. The electrolyte formulation according to claim 19, wherein the alkyl cellulose is ethyl cellulose.

21. The electrolyte formulation according to claim 15, wherein the thickening agent includes a poly-alkylene oxide.

22. The electrolyte formulation according to claim 21, wherein the poly-alkylene oxide is poly-ethylene oxide.

23. The electrolyte formulation according to claim 15, wherein the thickening agent includes a hydroxyl alkyl cellulose.

24. The electrolyte formulation according to claim 23, wherein the hydroxyl alkyl cellulose is hydroxy propyl cellulose.

25. The electrolyte formulation according to claim 15, wherein the thickening agent is selected from the group consisting of polyacrylonitrile, poly-vinyl acetate, poly(alkylene carbonate) copolymers, a poly vinyl alkyl ether and poly vinyl (m)ethyl ether.

26. The electrolyte formulation according to claim 15, wherein the thickening agent is present in an amount between 0.1 wt % to 20 wt %.

27. The electrolyte formulation according to claim 15, wherein the thickening agent is present in an amount between 2 wt % to 9 wt %.

28. The electrolyte formulation according to claim 15, wherein the thickening agent is present in an amount of about 6 wt %.

29. The electrolyte formulation according to claim 15, and further including a normally nanoparticulate metallic ion based compound.

30. The electrolyte formulation according to claim 15, which includes a nitrile based solvent.

31. A photoelectrochemical device including an electrolyte formulation comprising:
a thickening agent;
wherein the thickening agent is dissolved in the electrolyte; and
the thickening agent is polymeric.

32. The photoelectrochemical device according to claim 31, wherein the photoelectrochemical device is a dye-sensitised solar cell.
